(19) United States
(12) Patent Application Publication
(10) Pub. No.: US 2026/0264535 A1
(43) Pub. Date: Sep. 10, 2026

(54) VEHICLE CONTROL SYSTEM

(71) Applicant: HONDA MOTOR CO., LTD., Tokyo (JP)

(72) Inventor: Shotaro Yamazaki, Tokyo (JP)

(21) Appl. No.: 19/461,790

(22) Filed: Jan. 28, 2026

(30) Foreign Application Priority Data
Mar. 10, 2025 (JP) 2025-037195

(51) Int. Cl. B60L 15/20; B60L 50/60

(52) U.S. Cl. CPC B60L 15/20; B60L 50/60; B60L 2240/423; B60L 2240/465

(57) ABSTRACT

A vehicle control system includes a first traction control unit, a power generation control unit, and a second traction control unit. The first traction control unit sets required torque for each drive motor for desired vehicle behavior. The power generation control unit controls power balance among each drive motor, the power generation motor, and the battery according to the required torque, and sets instructed torque for each drive motor. The second traction control unit sets a torque threshold value for the instructed torque according to an allowable power range of the battery. When correction of the instructed torque to eliminate slip of wheels exceeds the torque threshold value, the second traction control unit restricts and stops the correction of the instructed torque, and causes the first traction control unit to set the required torque to eliminate slip of the wheels.

### CROSS-REFERENCE TO RELATED APPLICATION

Priority is claimed on Japanese Patent Application No. 2025-037195, filed Mar. 10, 2025, the entire content of which is incorporated herein by reference.

### BACKGROUND OF THE INVENTION

### Field of the Invention

The present invention relates to a vehicle control system.

### Description of Related Art

In recent years, efforts have been actively made to provide access to sustainable transportation systems that take into account people in vulnerable positions such as the elderly, persons with disabilities, and children among traffic participants. To realize this, focus is being placed on research and development to further improve traffic safety and convenience through development related to vehicle behavior stability.

Conventionally, for example, a hybrid vehicle is known which includes rotating electric machines for driving and power generation and an internal combustion engine, and which, when wheel slip occurs, executes slip suppression control by a control unit that controls the entire vehicle so that the charging and discharging power of a battery does not exceed allowable power (see, for example, Patent Document 1 below).

[Patent Document 1] Japanese Unexamined Patent Application, First Publication No. 2008-207715

### SUMMARY OF THE INVENTION

In vehicle behavior stability, when wheel slip occurs during acceleration or deceleration, a challenge is to quickly eliminate the slip while suppressing reduction in acceleration or deceleration and instability of vehicle behavior.

For example, in the above-described conventional hybrid vehicle, because the control unit that controls the entire vehicle executes processing such as feedback control of rotation speed and torque in slip suppression control, there is a possibility that quick slip elimination becomes difficult. To address such a problem, for example, by executing processing such as feedback control at high speed by a motor ECU that controls the rotating electric machine for driving according to a command value received from the control unit, the time required for slip elimination can be shortened.

However, when slip suppression control is executed by the motor ECU after the power balance is adjusted by the control unit, for example, if the allowable power of the battery decreases due to a low temperature state or the like, there is a possibility that the charging power of the battery becomes excessive accompanying the decrease in power consumption by the slip suppression control. In this case, if the slip suppression control is restricted by the motor ECU in order to suppress the charging power of the battery becoming excessive, there is a possibility that it becomes difficult to realize proper slip elimination.

An aspect according to the present invention has as its object to achieve properly eliminating wheel slip while maintaining a desired power balance in order to solve the above-described problem. Additionally, by extension, it contributes to the development of sustainable transportation systems.

In order to solve the above-described problem and achieve the object, the present invention employs the following aspects.

(1): A vehicle control system according to one aspect of the present invention includes: a first control unit configured to set a required torque for a first rotating electric machine that transmits and receives torque to and from wheels for desired vehicle behavior; a power control unit configured to set an instructed torque for the first rotating electric machine by controlling power balance among the first rotating electric machine, a second rotating electric machine for power generation and power dissipation, and a power storage device that transmits and receives electric power to and from the first rotating electric machine and the second rotating electric machine, according to the required torque; a rotating electric machine control unit configured to control operation of the first rotating electric machine based on the instructed torque; and a second control unit configured to correct the instructed torque in order to eliminate slip of the wheels, wherein the second control unit sets a torque threshold value for the instructed torque according to a predetermined allowable power range based on a power margin on a charging side and a discharging side of the power storage device, and when a post-correction instructed torque obtained by correction of the instructed torque to eliminate slip of the wheels exceeds the torque threshold value, restricts and stops the correction of the instructed torque, and causes the first control unit to set the required torque for eliminating slip of the wheels.

(2): In the above-described aspect (1), the setting of the required torque to eliminate slip of the wheels by the first control unit may be permitted when the torque threshold value changes.

(3): In the above-described aspect (1) or (2), the second control unit may restrict the correction of the instructed torque so that the post-correction instructed torque does not exceed the torque threshold value.

According to the above-described aspect (1), by including the second control unit that restricts correction of the instructed torque when the post-correction instructed torque exceeds the torque threshold value, occurrence of overcharging and overdischarging of the power storage device can be suppressed. The second control unit, accompanying the restriction of correction of the instructed torque, stops correction of the instructed torque and switches elimination of slip of the wheels to control by the first control unit, whereby continuation of improper torque control can be suppressed, and wheel slip can be properly eliminated.

In the case of the above-described aspect (2), because control of elimination of slip of the wheels by the first control unit is permitted when the torque threshold value changes, when correction of the instructed torque by the second control unit is stopped, switching to control by the first control unit can be performed quickly and smoothly.

In the case of the above-described aspect (3), because the second control unit restricts so that the post-correction instructed torque does not exceed the torque threshold value, occurrence of overcharging and overdischarging of the power storage device can be accurately suppressed.

### BRIEF DESCRIPTION OF THE DRAWINGS

FIG. 1 is a configuration diagram of a vehicle on which the vehicle control system of an embodiment of the present invention is mounted.

FIG. 2 is a block diagram showing a functional configuration of the vehicle control system in the embodiment of the present invention.

FIG. 3 is a graph diagram showing an example of correspondence relationships of target axle speed, axle speed, and vehicle body speed; first control torque, drive motor torque (before correction), drive motor torque (after correction), instructed torque (before correction), and torque threshold value; and permission flags and operation flags (first control, second control) during vehicle acceleration in the vehicle control system of the embodiment of the present invention.

FIG. 4 is a graph diagram showing an example of correspondence relationships of target axle speed, axle speed, and vehicle body speed; first control torque, drive motor torque (before correction), drive motor torque (after correction), instructed torque (before correction), and torque threshold value; and permission flags and operation flags (first control, second control) during vehicle deceleration in the vehicle control system of the embodiment of the present invention.

FIG. 5 is a flowchart showing operation of the vehicle control system in the embodiment of the present invention.

### DETAILED DESCRIPTION OF THE INVENTION

Hereinafter, a vehicle control system according to an embodiment of the present invention will be described with reference to the attached drawings.

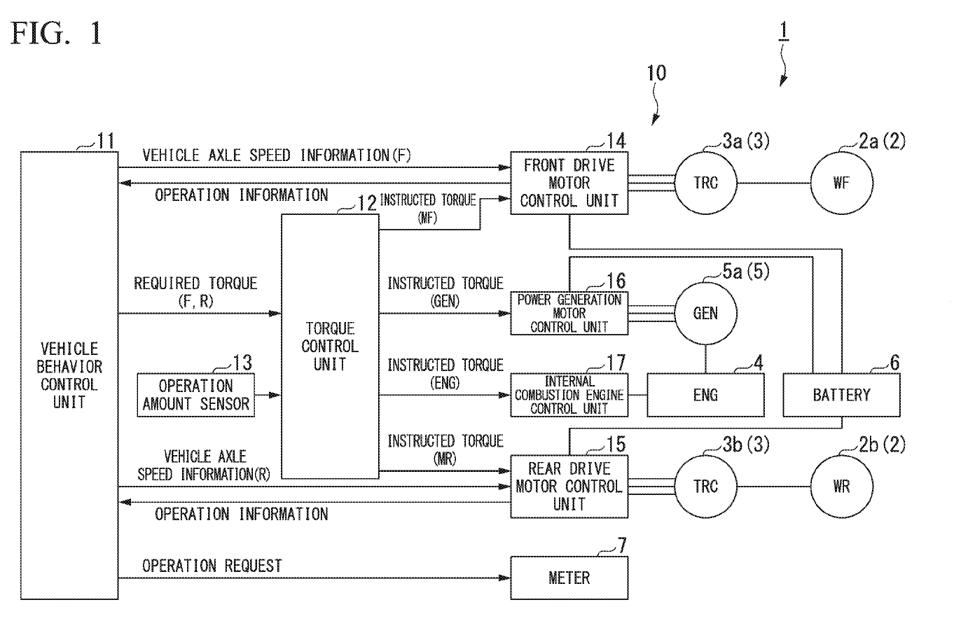

FIG. 1 is a configuration diagram of a vehicle 1 on which a vehicle control system 10 of the embodiment is mounted.

As shown in FIG. 1, the vehicle 1 on which the vehicle control system 10 of the embodiment is mounted is, for example, an electric vehicle such as a hybrid vehicle using a combination of a rotating electric machine and an internal combustion engine.

The vehicle 1 of the embodiment includes, for example, a plurality of rotating electric machines 3 for driving that transmit and receive torque to and from a plurality of wheels 2, an internal combustion engine 4, a rotating electric machine 5 for power generation, a battery 6 that transmits and receives electric power to and from each rotating electric machine 3, 5, and a meter 7 which is part of a notification device that presents various information to a driver.

Each rotating electric machine 3, 5 is, for example, a three-phase AC brushless DC motor or the like. The plurality of rotating electric machines 3 for driving are, for example, a front drive motor 3a (3) connected to left and right front wheels 2a (2), and a rear drive motor 3b (3) connected to left and right rear wheels 2b (2). Each rotating electric machine 3 for driving generates drive torque in each wheel 2 by performing powering operation using electric power supplied from a power conversion device or the like. Each rotating electric machine 3 for driving generates generated electric power and braking torque in each wheel 2 by performing regenerative operation using rotational power input from each wheel 2 side.

The rotating electric machine 5 for power generation is, for example, a power generation motor 5a (5) connected to the internal combustion engine 4. The rotating electric machine 5 for power generation generates electric power using rotational power input from the internal combustion engine 4.

The battery 6 is connected to each rotating electric machine 3, 5 via a power conversion device or the like, for example.

The meter 7 notifies various information according to signals such as operation request signals input from the vehicle control system 10. For example, the meter 7 notifies the driver of information indicating that various controls are in operation or stopped by operations such as blinking of a light body.

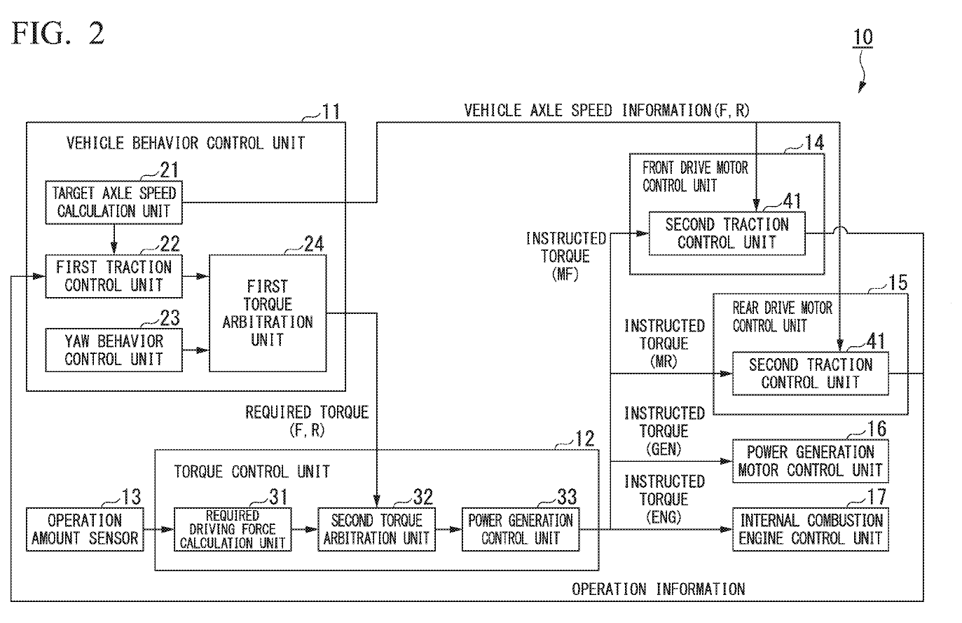

FIG. 2 is a block diagram showing a functional configuration of the vehicle control system 10 in the embodiment.

As shown in FIGS. 1 and 2, the vehicle control system 10 includes, for example, a vehicle behavior control unit 11, a torque control unit 12, an operation amount sensor 13, a front drive motor control unit 14, a rear drive motor control unit 15, a power generation motor control unit 16, and an internal combustion engine control unit 17.

Each control unit 11, 12, 14, 15, 16, 17 is a software function unit that functions by execution of a predetermined program by a processor such as a CPU (Central Processing Unit), for example. The software function unit is an ECU including electronic circuits such as a processor such as a CPU, a ROM (Read Only Memory) that stores programs, a RAM (Random Access Memory) that temporarily stores data, and a timer. At least a part of each control unit 11, 12, 14, 15, 16, 17 may be an integrated circuit such as an LSI (Large Scale Integration).

Each control unit 11, 12, 14, 15, 16, 17 acquires signals of detection values output from various sensors. The various sensors include, for example, the operation amount sensor 13, current sensors and voltage sensors, rotation angle sensors, acceleration sensors, wheel speed sensors, battery state sensors, and the like. The operation amount sensor 13 detects presence or absence of operation and operation amount of each of an accelerator operator and a brake operator by a driver. The current sensors and the voltage sensors detect current and voltage of each rotating electric machine 3, 5. The rotation angle sensors detect rotation angles of each rotating electric machine 3, 5. The acceleration sensors detect acceleration (including deceleration) of the vehicle 1. The wheel speed sensors detect rotation speeds (wheel speeds) of each wheel 2 of the vehicle 1. The battery state sensors detect various state quantities such as temperature of the battery 6, for example.

The vehicle behavior control unit 11 executes control for suppressing rapid changes in vehicle behavior and stabilizing posture. The vehicle behavior control unit 11 includes, for example, a target axle speed calculation unit 21, a first traction control unit 22, a yaw behavior control unit 23, and a first torque arbitration unit 24.

The target axle speed calculation unit 21 acquires, for example, signals of detection values output from the acceleration sensors and the wheel speed sensors, and acquires a speed (vehicle body speed) Vv and a target axle speed Vt of the vehicle 1 by predetermined calculation or map search or the like based on acceleration and wheel speed.

The target axle speed calculation unit 21 sets the target axle speed Vt independently for each of the plurality of rotating electric machines 3 for driving, for example. The first traction control unit 22 sets the target axle speed Vt for each of the front drive motor 3a (3) that transmits and receives torque to and from the left and right front wheels 2a (2) and the rear drive motor 3b (3) that transmits and receives torque to and from the left and right rear wheels 2b (2), for example. The target axle speed calculation unit 21 transmits, for example, each of axle speed information (F) and axle speed information (R) including the target axle speed Vt set for each of the front wheels 2a and the rear wheels 2b to the front drive motor control unit 14 and the rear drive motor control unit 15 described later.

The first traction control unit 22 executes first control that is complementarily switched with second control executed by a second traction control unit 41 of each of the front drive motor control unit 14 and the rear drive motor control unit 15, as will be described later. The first traction control unit 22 executes the first control according to operation permission information input from the second traction control unit 41, for example.

Each of the first control and the second control secures desired driving force, braking force, and steering capability by suppressing slipping (so-called slip) of the wheels 2 on slippery road surfaces or the like, for example. Each of the first control and the second control suppresses slip due to idling of the wheels 2 (driving wheels) during vehicle acceleration by reduction of torque, like so-called TCS (Traction Control System), for example. Each of the first control and the second control suppresses slip due to locking of the wheels 2 during vehicle deceleration by increase of torque, like so-called EDC (Engine Drag torque Control), for example.

As will be described in detail later, the first control is executed prior to setting of power balance by the torque control unit 12, and the second control is executed after setting of power balance by the torque control unit 12.

In the first control, the first traction control unit 22 executes feedback control on rotation speed and torque of each rotating electric machine 3 for driving based on, for example, the target axle speed Vt input from the target axle speed calculation unit 21 and detection values input from various sensors. The first traction control unit 22 acquires, for example, detection values of rotation speed output from the rotation angle sensors of each rotating electric machine 3, and acquires an axle speed Vw in a speed dimension according to the rotation speed of each rotating electric machine 3. The first traction control unit 22 sets a post-correction required torque by correcting the required torque set for each wheel 2 before slip occurrence in order to eliminate slip of each wheel 2 by the first control, based on comparison between the axle speed Vw and the target axle speed Vt, for example. The first traction control unit 22 sets each of required torque (F) and required torque (R) for each of the front wheels 2a and the rear wheels 2b, for example.

The first traction control unit 22 receives, for example, operation information transmitted from the second traction control unit 41 of each of the front drive motor control unit 14 and the rear drive motor control unit 15 described later. The operation information received from the second traction control unit 41 includes, for example, information indicating operation permission of the first control by the first traction control unit 22, information on an operation state of the second control by the second traction control unit 41, and the like. The first traction control unit 22 determines necessity of execution of the first control based on the operation information received from the second traction control unit 41, for example, and instructs the meter 7 to execute notification that the first control or the second control is in operation or stopped.

The yaw behavior control unit 23 secures desired turning performance and running stability by various behavior controls such as so-called AYC (Active Yaw Control). The yaw behavior control unit 23 sets required torque for controlling various behaviors such as yaw of the vehicle 1 based on driving force and braking force between the left and right wheels 2, for example.

The first torque arbitration unit 24 executes predetermined torque arbitration processing based on, for example, the required torque set by the first traction control unit 22 and the required torque set by the yaw behavior control unit 23. The first torque arbitration unit 24 optimizes torque distribution to the front, rear, left, and right wheels 2 in various running states such as acceleration, deceleration, and turning of the vehicle 1, for example, and sets required torque for each rotating electric machine 3 for driving for desired vehicle behavior. The first torque arbitration unit 24 sets each of required torque (F) and required torque (R) for each of the front wheels 2a and the rear wheels 2b, for example. The first torque arbitration unit 24 transmits each required torque (F, R) toward the torque control unit 12.

The first torque arbitration unit 24 outputs the required torque set by the yaw behavior control unit 23 without executing the predetermined torque arbitration processing when the first control by the first traction control unit 22 is not being executed, for example.

The torque control unit 12 includes, for example, a required driving force calculation unit 31, a second torque arbitration unit 32, and a power generation control unit 33.

The required driving force calculation unit 31 acquires a required driving force by a driver by predetermined calculation or map search or the like based on information on presence or absence of operation and operation amount of each of the accelerator operator and the brake operator by the driver output from the operation amount sensor 13.

The second torque arbitration unit 32 executes predetermined torque arbitration processing based on, for example, the required torque output from the first torque arbitration unit 24 and the required driving force output from the required driving force calculation unit 31. The second torque arbitration unit 32 controls torque distributed to each wheel 2 by setting required torque for each rotating electric machine 3 for driving for desired vehicle behavior according to requests from the driver and the vehicle behavior control unit 11, for example. The second torque arbitration unit 32 sets each of required torque (F) and required torque (R) for each of the front wheels 2a and the rear wheels 2b, for example.

The power generation control unit 33 sets power balance among each rotating electric machine 3, 5, various auxiliary loads, the battery 6, and the like based on the required torque output from the second torque arbitration unit 32, for example. The power generation control unit 33 sets consistency of power balance by, for example, powering (consumption) and regeneration of each rotating electric machine 3 for driving, power generation and power discharge (power dissipation) of the rotating electric machine 5 for power generation, consumption of various auxiliary loads, charging and discharging within a predetermined allowable power range of the battery 6, and the like. The power generation control unit 33 sets instructed torque for each of the rotating electric machines 3, 5 and the internal combustion engine 4 according to setting of the power balance. The power generation control unit 33 sets, for example, instructed torque (MF) for the front drive motor 3a and instructed torque (MR) for the rear drive motor 3b, instructed torque (GEN) for the power generation motor 5a, and instructed torque (ENG) for the internal combustion engine 4. The power generation control unit 33 transmits each instructed torque (MF, MR, GEN, ENG) toward each of the motor control units 14, 15, 16 and the internal combustion engine control unit 17.

Each of the front drive motor control unit 14 and the rear drive motor control unit 15 includes a power conversion device connected to a power source such as the battery 6 mounted on the vehicle 1 and each of the front drive motor 3a and the rear drive motor 3b, for example. Each drive motor control unit 14, 15 controls power transmission and reception of each drive motor 3a, 3b via a power conversion device configured by a plurality of switching elements or the like according to each instructed torque (MF, MR) input from the torque control unit 12, for example. Each drive motor control unit 14, 15 generates rotational driving force by sequentially commutating energization to three-phase stator windings of each drive motor 3a, 3b during powering operation of each drive motor 3a, 3b. Each drive motor control unit 14, 15 converts three-phase AC power input from three-phase stator windings into DC power by switching operation of each phase synchronized with rotation of each drive motor 3a, 3b during regenerative operation of each drive motor 3a, 3b.

In torque control of each wheel 2, each drive motor control unit 14, 15 executes feedback control on rotation speed and torque of each drive motor 3a, 3b based on, for example, the target axle speed Vt input from the target axle speed calculation unit 21, the instructed torque (MF, MR) input from the power generation control unit 33, and detection values input from various sensors.

Each drive motor control unit 14, 15 includes a second traction control unit 41 that executes second control that is complementarily switched with the first control executed by the first traction control unit 22. The second traction control unit 41 executes the second control preferentially over the first traction control unit 22 that executes the first control in an appropriate reference state such as at system startup, for example.

The second traction control unit 41 acquires, for example, detection values of rotation speed output from the rotation angle sensors of each drive motor 3a, 3b, and acquires an axle speed Vw in a speed dimension according to the rotation speed of each drive motor 3a, 3b. The second traction control unit 41 sets each post-correction instructed torque (MF, MR) by correcting each instructed torque (MF, MR) set before slip occurrence when eliminating slip of each of the front wheels 2a and the rear wheels 2b by the second control, based on comparison between the axle speed Vw and the target axle speed Vt, for example.

The second traction control unit 41 restricts so that a correction amount of each instructed torque (MF, MR) does not exceed a torque amount corresponding to a power margin in each of charging and discharging of the battery 6 when correcting each instructed torque (MF, MR), for example.

The second traction control unit 41 acquires estimated power based on, for example, each instructed torque (MF, MR, GEN) input from the power generation control unit 33 and rotation speeds of each of the drive motors 3a, 3b and the power generation motor 5a, and the like. The estimated power is power obtained by balancing of power balance among powering (consumption) of each drive motor 3a, 3b and power generation of the power generation motor 5a and consumption of various auxiliary loads during vehicle acceleration, for example. The estimated power is power obtained by balancing of power balance among regeneration of each drive motor 3a, 3b and power discharge (power dissipation) of the power generation motor 5a and consumption of various auxiliary loads during vehicle deceleration, for example. The second traction control unit 41 acquires a predetermined allowable power range by power margin in each of the discharging side and the charging side of the battery 6 with the estimated power as a reference, for example. The second traction control unit 41 acquires an allowable power range of the battery 6 by reference to a predetermined map or predetermined calculation or the like based on detection values of various state quantities such as temperature of the battery 6 output from the battery state sensors, for example. The predetermined map or the predetermined calculation or the like indicates power margin in each of the discharging side and the charging side that changes according to various state quantities of the battery 6, for example.

The second traction control unit 41 acquires an upper limit value of a correction amount of each instructed torque (MF, MR) according to a torque range corresponding to the predetermined allowable power range of the battery 6, for example. The upper limit values of the correction amounts of each instructed torque (MF, MR) are, for example, an upper limit value ΔTt1 of a torque reduction correction amount corresponding to a power margin on the charging side of the battery 6, and an upper limit value ΔTt2 of a torque increase correction amount corresponding to a power margin on the discharging side of the battery 6. The second traction control unit 41 sets a torque threshold value Tth which is a threshold value of each post-correction instructed torque (MF, MR) according to the upper limit values of the correction amounts of each instructed torque (MF, MR), for example.

The second traction control unit 41 sets operation permission of the first control by the first traction control unit 22 when there is a possibility that the correction amount of each instructed torque (MF, MR) will be restricted during operation of the second control according to the torque threshold value Tth, for example. Furthermore, when the correction amount of each instructed torque (MF, MR) is restricted during operation of the second control, the second traction control unit 41 stops and prohibits operation of the second control. The second traction control unit 41 transmits operation information including information indicating operation permission of the first control, information on an operation state (during restriction and during prohibition) of the second control, and the like toward the first traction control unit 22.

The power generation motor control unit 16 includes a power conversion device connected to the battery 6 and the power generation motor 5a, for example. The power generation motor control unit 16 controls power transmission and reception of the power generation motor 5a via a power conversion device configured by a plurality of switching elements or the like according to the instructed torque (GEN) input from the power generation control unit 33, for example. The power generation motor control unit 16 converts three-phase AC power input from three-phase stator windings into DC power by switching operation of each phase synchronized with rotation of the power generation motor 5a during power generation operation of the power generation motor 5a by rotational power input from the internal combustion engine 4. The power generation motor control unit 16 generates rotational driving force by sequentially commutating energization to three-phase stator windings of the power generation motor 5a during a power discharge (dissipative) operation of the power generation motor 5a, and generates mechanical loss in the internal combustion engine 4 connected to the power generation motor 5a.

The internal combustion engine control unit 17 controls operation of the internal combustion engine 4 according to the instructed torque (ENG) input from the power generation control unit 33.

Hereinafter, an operation example of the vehicle control system 10 in the embodiment will be described.

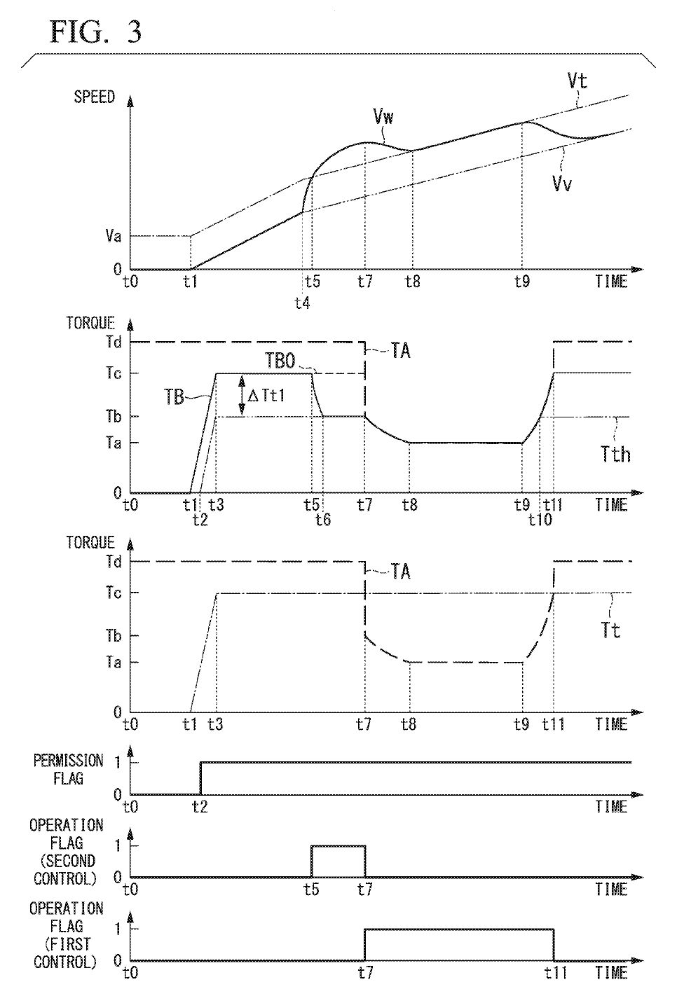

FIG. 3 is a graph diagram showing an example of correspondence relationships of target axle speed Vt, axle speed Vw, and vehicle body speed Vv; first control torque TA, drive motor torque (before correction) TB0, drive motor torque (after correction) TB, instructed torque (before correction) Tt, and torque threshold value Tth; and permission flags and operation flags (first control, second control) during vehicle acceleration of the vehicle control system 10 of the embodiment.

During vehicle acceleration as shown in FIG. 3, first, as after time t0, for example, the target axle speed Vt is set to a predetermined value Va larger than an appropriate value in a state where the axle speed Vw and the vehicle body speed Vv are at an appropriate value such as zero. The first control torque TA which is an instructed torque set in advance for the rotating electric machine 3 for driving in the first control is set to a predetermined value Td, for example.

Next, as after time t1, for example, as the axle speed Vw and the vehicle body speed Vv increase from an appropriate value such as zero, the target axle speed Vt is set so as to increase from the predetermined value Va. The instructed torque (before correction) Tt for the rotating electric machine 3 for driving set by the power generation control unit 33 increases from an appropriate value such as zero. Accompanying the increase in the instructed torque (before correction) Tt, the drive motor torque (before correction) TB0 and the drive motor torque (after correction) TB, which are torques of the rotating electric machine 3 obtained by torque control of each drive motor control unit 14, 15, increase from an appropriate value such as zero.

Next, as after time t2, for example, the torque threshold value Tth, which is a threshold value (lower limit value) of the instructed torque for the rotating electric machine 3 for driving set by the second traction control unit 41, increases from an appropriate value such as zero according to changes in power situation accompanying the increase in each torque TB0, TB. The torque threshold value Tth changes from an appropriate value such as zero according to state changes such as temperature decrease of the battery 6, for example. Accompanying the increase change of the torque threshold value Tth, in advance, a permission flag indicating operation permission of the first control by the first traction control unit 22 is switched from off ("0") to on ("1") by the second traction control unit 41.

Next, as after time t3, for example, as the instructed torque (before correction) Tt reaches a predetermined value Tc, the drive motor torque (before correction) TB0 and the drive motor torque (after correction) TB reach the predetermined value Tc, and the torque threshold value Tth reaches a predetermined value Tb (<Tc) smaller than the predetermined value Tc. For example, the upper limit value ΔTt1 of the torque reduction correction amount corresponding to a power margin on the charging side of the battery 6 set by the second traction control unit 41 is the difference between the predetermined value Tc and the predetermined value Tb (=Tc−Tb).

Next, as after time t4, as the axle speed Vw increases to equal to or greater than the vehicle body speed Vv due to occurrence of slip, the rate of increase of each of the target axle speed Vt and the vehicle body speed Vv decreases.

Next, as after time t5, as the axle speed Vw increases to equal to or greater than the target axle speed Vt, the second traction control unit 41 starts operation of the second control for suppressing slip, and switches an operation flag (second control) from off ("0") to on ("1"). Accompanying the operation of the second control, the instructed torque (before correction) Tt for the rotating electric machine 3 is corrected and a post-correction instructed torque is set, whereby the drive motor torque (after correction) TB is reduced so as to change to a decreasing tendency. For example, whereas the drive motor torque (before correction) TB0 maintains the predetermined value Tc, the drive motor torque (after correction) TB decreases from the predetermined value Tc.

Next, as after time t6, when the drive motor torque (after correction) TB reaches the torque threshold value Tth, the second traction control unit 41 restricts the correction amount of the instructed torque (before correction) Tt so that the drive motor torque (after correction) TB does not decrease below the torque threshold value Tth. By the restriction of the correction amount, the drive motor torque (after correction) TB is maintained at the torque threshold value Tth which is the predetermined value Tb, for example.

Next, as after time t7, the first traction control unit 22 starts operation of the first control for suppressing slip. After restricting the correction amount of the instructed torque (before correction) Tt during operation of the second control, the second traction control unit 41 stops and prohibits operation of the second control. The first traction control unit 22 switches an operation flag (first control) from off ("0") to on ("1"), for example. The second traction control unit 41 switches an operation flag (second control) from on ("1") to off ("0"), for example.

Accompanying the operation of the first control, after correction of the required torque for eliminating slip by the first traction control unit 22, setting of consistency of power balance by the power generation control unit 33 is executed, whereby the first control torque TA is reduced so as to change to a decreasing tendency compared to the torque threshold value Tth during operation of the second control before time t7. For example, the power generation control unit 33 reduces power consumption of the rotating electric machine 3 for driving so that charging power of the battery 6 does not exceed a predetermined allowable power range based on power margin on the charging side by reducing generated electric power of the rotating electric machine 5 for power generation. The torque threshold value Tth and the drive motor torque (after correction) TB according to the predetermined allowable power range of the battery 6 decrease below the predetermined value Tb which is the torque threshold value Tth during operation of the second control before time t7 together with the first control torque TA.

Accompanying the operation of the first control, the axle speed Vw changes to a decreasing tendency by optimization of slip suppression operation.

Next, as after time t8, as the axle speed Vw reaches the target axle speed Vt, the first traction control unit 22 stops the decrease in required torque, whereby the decrease in each of the first control torque TA, the torque threshold value Tth, and the drive motor torque (after correction) TB is stopped. For example, each of the first control torque TA, the torque threshold value Tth, and the drive motor torque (after correction) TB is maintained at a predetermined value Ta (<Tb) smaller than the predetermined value Tb.

Next, as after time t9, as the axle speed Vw decreases to equal to or less than the target axle speed Vt, the first traction control unit 22 relaxes correction of the required torque, whereby each of the first control torque TA, the torque threshold value Tth, and the drive motor torque (after correction) TB changes to an increasing tendency.

Next, as after time t10, according to changes in the allowable power range of the battery 6, for example, the torque threshold value Tth is maintained at the predetermined value Tb, which is the value during operation of the second control.

Next, as after time t11, when each of the first control torque TA and the drive motor torque (after correction) TB reaches the instructed torque (before correction) Tt, the first traction control unit 22 stops operation of the first control. The first traction control unit 22 switches an operation flag (first control) from on ("1") to off ("0"), for example. Accompanying the stop of operation of the first control, the first control torque TA is maintained at a value before operation of the first control, for example, the predetermined value Td. The drive motor torque (after correction) TB is maintained at a value before operation of the second control, for example, the instructed torque (before correction) Tt which is the predetermined value Tc.

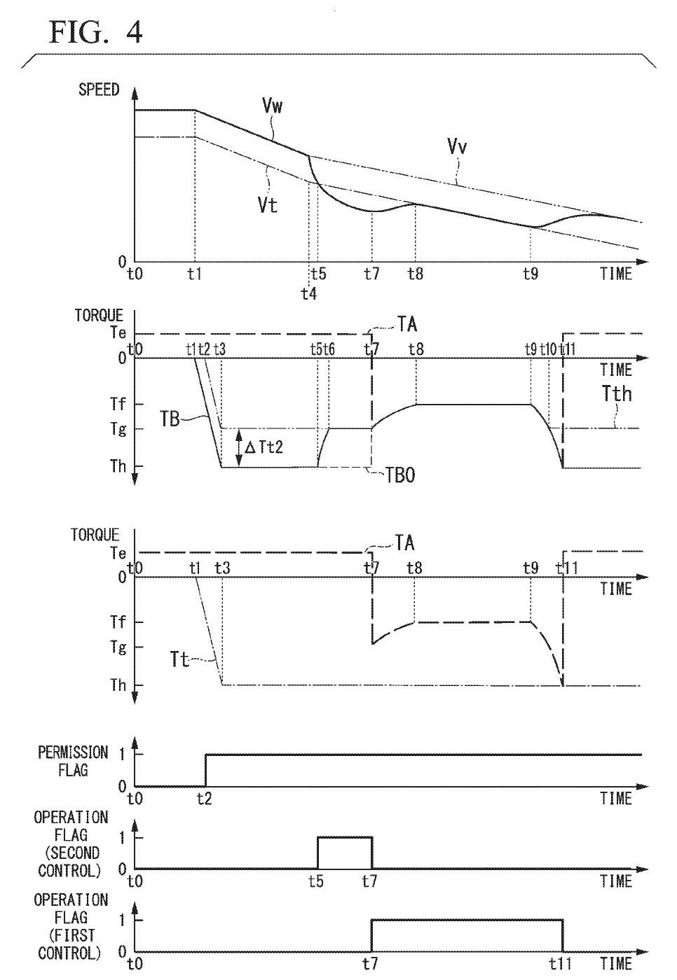

FIG. 4 is a graph diagram showing an example of correspondence relationships of target axle speed Vt, axle speed Vw, and vehicle body speed Vv; first control torque TA, drive motor torque (before correction) TB0, drive motor torque (after correction) TB, instructed torque (before correction) Tt, and torque threshold value Tth; and permission flags and operation flags (first control, second control) during vehicle deceleration of the vehicle control system 10 of the embodiment.

During vehicle deceleration as shown in FIG. 4, first, as after time t0, for example, the target axle speed Vt is set to a predetermined value smaller than an appropriate value in a state where the axle speed Vw and the vehicle body speed Vv are at an appropriate value larger than zero. The first control torque TA which is an instructed torque set in advance for the rotating electric machine 3 for driving in the first control is set to a predetermined value Te, for example.

Next, as after time t1, for example, as the axle speed Vw and the vehicle body speed Vv decrease from an appropriate value, the target axle speed Vt is set so as to decrease from the predetermined value. The instructed torque (before correction) Tt for the rotating electric machine 3 for driving set by the power generation control unit 33 decreases from an appropriate value such as zero. Accompanying the decrease in the instructed torque (before correction) Tt, the drive motor torque (before correction) TB0 and the drive motor torque (after correction) TB, which are torques of the rotating electric machine 3 obtained by torque control of each drive motor control unit 14, 15, decrease from an appropriate value such as zero.

Next, as after time t2, for example, the torque threshold value Tth, which is a threshold value (upper limit value) of the instructed torque for the rotating electric machine 3 for driving set by the second traction control unit 41, decreases from an appropriate value such as zero according to changes in power situation accompanying the decrease in each torque TB0, TB. The torque threshold value Tth changes from an appropriate value such as zero according to state changes such as temperature decrease of the battery 6, for example. Accompanying the decrease change of the torque threshold value Tth, in advance, a permission flag indicating operation permission of the first control by the first traction control unit 22 is switched from off ("0") to on ("1") by the second traction control unit 41.

Next, as after time t3, for example, as the instructed torque (before correction) Tt reaches a predetermined value Th, the drive motor torque (before correction) TB0 and the drive motor torque (after correction) TB reach the predetermined value Th, and the torque threshold value Tth reaches a predetermined value Tg (>Th) larger than the predetermined value Th. For example, the upper limit value ΔTt2 of the torque increase correction amount corresponding to a power margin on the discharging side of the battery 6 set by the second traction control unit 41 is the difference between the predetermined value Th and the predetermined value Tg (=Tg−Th).

Next, as after time t4, as the axle speed Vw decreases to equal to or less than the vehicle body speed Vv due to occurrence of slip, the rate of decrease of each of the target axle speed Vt and the vehicle body speed Vv decreases.

Next, as after time t5, as the axle speed Vw decreases to equal to or less than the target axle speed Vt, the second traction control unit 41 starts operation of the second control for suppressing slip, and switches an operation flag (second control) from off ("0") to on ("1"). Accompanying the operation of the second control, the instructed torque (before correction) Tt for the rotating electric machine 3 is corrected and a post-correction instructed torque is set, whereby the drive motor torque (after correction) TB is increased so as to change to an increasing tendency. For example, whereas the drive motor torque (before correction) TB0 maintains the predetermined value Th, the drive motor torque (after correction) TB increases from the predetermined value Th.

Next, as after time t6, when the drive motor torque (after correction) TB reaches the torque threshold value Tth, the second traction control unit 41 restricts the correction amount of the instructed torque (before correction) Tt so that the drive motor torque (after correction) TB does not increase larger than the torque threshold value Tth. By the restriction of the correction amount, the drive motor torque (after correction) TB is maintained at the torque threshold value Tth which is the predetermined value Tg, for example.

Next, as after time t7, the first traction control unit 22 starts operation of the first control for suppressing slip. After restricting the correction amount of the instructed torque (before correction) Tt during operation of the second control, the second traction control unit 41 stops and prohibits operation of the second control. The first traction control unit 22 switches an operation flag (first control) from off ("0") to on ("1"), for example. The second traction control unit 41 switches an operation flag (second control) from on ("1") to off ("0"), for example.

Accompanying the operation of the first control, after correction of the required torque for eliminating slip by the first traction control unit 22, setting of consistency of power balance by the power generation control unit 33 is executed, whereby the first control torque TA is increased so as to change to an increasing tendency compared to the torque threshold value Tth during operation of the second control before time t7. For example, the power generation control unit 33 reduces regenerative power of the rotating electric machine 3 for driving so that discharging power of the battery 6 does not exceed a predetermined allowable power range based on power margin on the discharging side by reducing power dissipation power of the rotating electric machine 5 for power generation. The torque threshold value Tth and the drive motor torque (after correction) TB according to the predetermined allowable power range of the battery 6 increase above the predetermined value Tg which is the torque threshold value Tth during operation of the second control before time t7 together with the first control torque TA.

Accompanying the operation of the first control, the axle speed Vw changes to an increasing tendency by optimization of slip suppression operation.

Next, as after time t8, as the axle speed Vw reaches the target axle speed Vt, the first traction control unit 22 stops the increase in required torque, whereby the increase in each of the first control torque TA, the torque threshold value Tth, and the drive motor torque (after correction) TB is stopped. For example, each of the first control torque TA, the torque threshold value Tth, and the drive motor torque (after correction) TB is maintained at a predetermined value Tf (>Tg) larger than the predetermined value Tg.

Next, as after time t9, as the axle speed Vw increases to equal to or greater than the target axle speed Vt, the first traction control unit 22 relaxes correction of the required torque, whereby each of the first control torque TA, the torque threshold value Tth, and the drive motor torque (after correction) TB changes to a decreasing tendency.

Next, as after time t10, according to changes in the allowable power range of the battery 6, for example, the torque threshold value Tth is maintained at the predetermined value Tg, which is the value during operation of the second control.

Next, as after time t11, when each of the first control torque TA and the drive motor torque (after correction) TB reaches the instructed torque (before correction) Tt, the first traction control unit 22 stops operation of the first control. The first traction control unit 22 switches an operation flag (first control) from on ("1") to off ("0"), for example. Accompanying the stop of operation of the first control, the first control torque TA is maintained at a value before operation of the first control, for example, the predetermined value Te. The drive motor torque (after correction) TB is maintained at a value before operation of the second control, for example, the instructed torque (before correction) Tt which is the predetermined value Th.

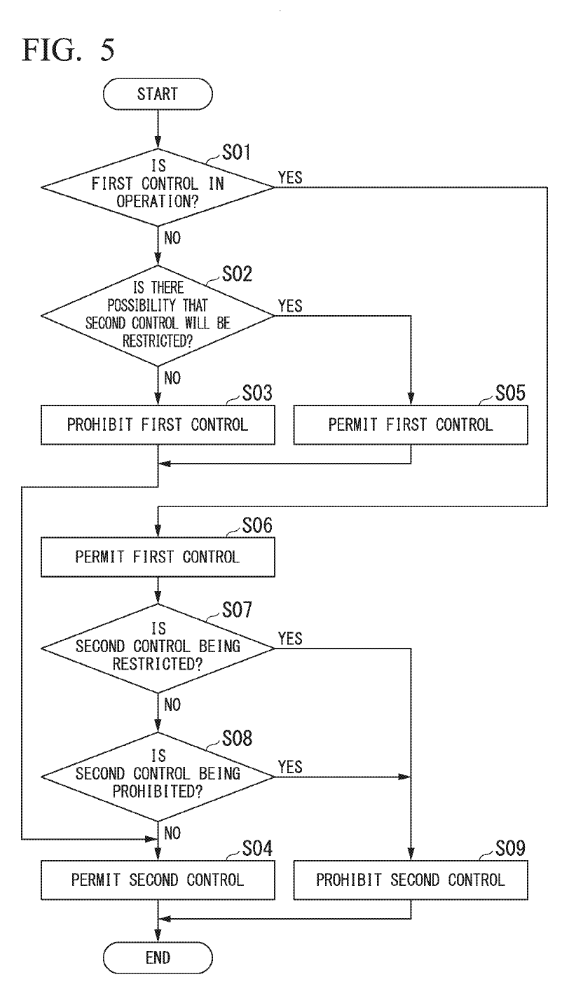

FIG. 5 is a flowchart showing operation of the vehicle control system 10 of the embodiment. For example, a series of processing from step S01 to step S09 shown in FIG. 5 is repeatedly executed at a predetermined cycle or the like.

As shown in FIG. 5, first, the second traction control unit 41 determines whether or not the first control by the first traction control unit 22 is in operation (step S01). If this determination result is "YES", the second traction control unit 41 advances the processing to step S06. On the other hand, if this determination result is "NO", the second traction control unit 41 advances the processing to step S02.

Next, the second traction control unit 41 determines whether or not there is a possibility that the second control will be restricted by referring to the torque threshold value Tth, for example (step S02). If this determination result is "YES", the second traction control unit 41 advances the processing to step S05. On the other hand, if this determination result is "NO", the second traction control unit 41 advances the processing to step S03.

Next, the second traction control unit 41 prohibits operation of the first control (step S03).

Next, the second traction control unit 41 permits operation of the second control (step S04). Then, the second traction control unit 41 advances the processing to end.

The second traction control unit 41 permits operation of the first control (step S05). Then, the second traction control unit 41 advances the processing to step S04. In this case, the second traction control unit 41 gives priority to operation of the second control over operation of the first control, for example.

The second traction control unit 41 permits operation of the first control (step S06).

Next, the second traction control unit 41 determines whether or not restriction of the correction amount of each instructed torque (MF, MR) in the second control is in progress (step S07). If this determination result is "YES", the second traction control unit 41 advances the processing to step S09. On the other hand, if this determination result is "NO", the second traction control unit 41 advances the processing to step S08.

Next, the second traction control unit 41 determines whether or not prohibition of operation of the second control is in progress (step S08). If this determination result is "YES", the second traction control unit 41 advances the processing to step S09. On the other hand, if this determination result is "NO", the second traction control unit 41 advances the processing to step S04. In this case, the second traction control unit 41 gives priority to operation of the second control over operation of the first control, for example.

The second traction control unit 41 prohibits operation of the second control (step S09). Then, the second traction control unit 41 advances the processing to end.

As described above, according to the vehicle control system 10 of the embodiment, by including the second traction control unit 41 that restricts correction of each instructed torque (MF, MR) when each post-correction instructed torque (MF, MR) exceeds the torque threshold value Tth, occurrence of overcharging and overdischarging of the battery 6 can be suppressed. The second traction control unit 41, accompanying restriction of correction of each instructed torque (MF, MR), stops correction of each instructed torque (MF, MR) and switches elimination of slip to control by the first traction control unit 22, whereby continuation of improper torque control can be suppressed, and slip of the wheels 2 can be properly eliminated.

Because operation permission of the first control by the first traction control unit 22 is permitted when the torque threshold value Tth changes, when the second control by the second traction control unit 41 is stopped, switching to the first control can be performed quickly and smoothly.

Because the second traction control unit 41 restricts in the second control so that each post-correction instructed torque (MF, MR) does not exceed the torque threshold value Tth, occurrence of overcharging and overdischarging of the battery 6 can be accurately suppressed.

### Modified Example

Hereinafter, a modified example of the embodiment will be described. For the same parts as the above-described embodiment, the same reference numerals are assigned and description is omitted or simplified.

In the above-described embodiment, the vehicle 1 includes the front drive motor 3a (3) connected to the left and right front wheels 2a (2) and the rear drive motor 3b (3) connected to the left and right rear wheels 2b (2), but is not limited thereto. For example, the vehicle 1 may include rotating electric machines 3 individually connected to each wheel 2, or may include rotating electric machines 3 individually for each of appropriate combinations of a plurality of wheels 2.

The embodiments of the present invention have been presented as examples and are not intended to limit the scope of the invention. These embodiments can be implemented in various other forms, and various omissions, replacements, and changes can be made without departing from the gist of the invention. These embodiments and their modifications are included in the scope and gist of the invention, and are included in the invention described in the claims and the scope of equivalents thereof.

What is claimed is:

1. A vehicle control system comprising:
a first control unit configured to set a required torque for a first rotating electric machine that transmits and receives torque to and from wheels for desired vehicle behavior;
a power control unit configured to set an instructed torque for the first rotating electric machine by controlling power balance among the first rotating electric machine, a second rotating electric machine for power generation and power dissipation, and a power storage device that transmits and receives electric power to and from the first rotating electric machine and the second rotating electric machine, according to the required torque;
a rotating electric machine control unit configured to control operation of the first rotating electric machine based on the instructed torque; and
a second control unit configured to correct the instructed torque in order to eliminate slip of the wheels,
wherein the second control unit sets a torque threshold value for the instructed torque according to a predetermined allowable power range based on a power margin on a charging side and a discharging side of the power storage device, and when a post-correction instructed torque obtained by correction of the instructed torque to eliminate slip of the wheels exceeds the torque threshold value, restricts and stops the correction of the instructed torque, and causes the first control unit to set the required torque for eliminating slip of the wheels.

2. The vehicle control system according to claim 1, wherein
the setting of the required torque to eliminate slip of the wheels by the first control unit is permitted when the torque threshold value changes.

3. The vehicle control system according to claim 1, wherein
the second control unit restricts the correction of the instructed torque so that the post-correction instructed torque does not exceed the torque threshold value.
